(19) United States
(12) Patent Application Publication
(10) Pub. No.: US 2016/0174757 A1
(43) Pub. Date: Jun. 23, 2016

(54) Brewing Cartridge Lockout Bypass

(71) Applicant: Adrian Rivera, Whittier, CA (US)

(72) Inventor: Adrian Rivera, Whittier, CA (US)

(21) Appl. No.: 14/978,377

(22) Filed: Dec. 22, 2015

Related U.S. Application Data
(60) Provisional application No. 62/096,478, filed on Dec. 23, 2014.

(51) Int. Cl. A47J 31/44

(52) U.S. Cl. CPC A47J 31/4492

(57) ABSTRACT

Inserts provide machine readable visual indicia, allowing use of brewing cartridges which do not include the required machine readable indicia, in brewing machines requiring the required machine readable visual indicia for operation. The insert may include features for attachment to the brewing machine, or to the brewing cartridge. The machine readable indicia may be a color, an image, a bar code, a texture, a shape, a reflective surface, a readable magnetic strip, a Radio Frequency Identification (RFID), or a combination of one or more of a color, image, a bar code, a texture, a shape, and a reflective surface, a readable magnetic strip, a Radio Frequency Identification (RFID) or any machine readable visual indicia.

### CROSS-REFERENCE TO RELATED APPLICATIONS

The present application claims the priority of US Provisional Patent Application Ser. No. 62/096,478 filed Dec. 23, 2014, which application is incorporated in its entirety herein by reference.

### BACKGROUND OF THE INVENTION

The present invention relates to brewing machines and in particular to a brewing machine insert allowing use of various brewing cartridges in a brewing machine including a lockout which normally prevents use of third party brewing cartridges.

Brewing machines using disposable single use brewing cartridges have become very popular. Unfortunately, the single use brewing cartridges offer a limited variety of brewed drink and are often expensive. Various reusable adapters have been developed to overcome the limited variety and expense of the single use brewing cartridges and offer consumers a lower cost option and the ability to use their preferred brewing material.

Unfortunately, some brewing machines require a machine readable visual indicia to identify the type of brewing cartridge in the machine to provide a correct amount of water. The requirement for an indicia prevents use of brewing cartridges which do not include the required machine readable visual indicia in these brewing machines.

### BRIEF SUMMARY OF THE INVENTION

The present invention addresses the above and other needs by providing inserts including machine readable indicia, allowing use of brewing cartridges which do not include the required machine readable visual indicia, in brewing machines requiring the required machine readable visual indicia for operation. The insert may include features for attachment to the brewing machine, or to the brewing cartridge. The machine readable indicia may be a color, an image, a bar code, a texture, a shape, a reflective surface, a readable magnetic strip, a Radio Frequency Identification (RFID), or a combination of one or more of a color, image, a bar code, a texture, a shape, and a reflective surface, a readable magnetic strip, a Radio Frequency Identification (RFID) or any machine readable visual indicia.

In accordance with one aspect of the invention, there is provided a ring including hooked tabs reaching over a cartridge rim for attachment to a brewing cartridge. The apart hooked tabs are preferably three angularly spaced apart hooked tabs reaching over, outside, and under the cartridge rim, the three hooked tabs including a center hooked tab and two side hooked tabs each extending more than 90 degrees from the center of the center tab.

### BRIEF DESCRIPTION OF THE SEVERAL VIEWS OF THE DRAWING

The above and other aspects, features and advantages of the present invention will be more apparent from the following more particular description thereof, presented in conjunction with the following drawings wherein:

FIG. 1 is an open brewing machine according to the present invention.

FIG. 2 is the open brewing machine with a lockout plate according to the present invention attached to a cartridge positioner of the brewing machine.

FIG. 3 is a top view of the lockout plate according to the present invention.

FIG. 4A is a bottom view of the lockout plate according to the present invention.

FIG. 4B is a top view of the lockout plate according to the present invention.

FIG. 4C is an end view of the lockout plate according to the present invention.

FIG. 4D is a side view of the lockout plate according to the present invention.

FIG. 4E is an end view of a sheet metal lockout plate according to the present invention.

FIG. 5 is a perspective side view of a brewing cartridge.

FIG. 6A is a perspective side view of the brewing cartridge with a lockout ring according to the present invention attached.

FIG. 6B is a perspective top and side view of the brewing cartridge with a lockout ring according to the present invention attached.

FIG. 6C is a perspective bottom and side view of the brewing cartridge with a lockout ring according to the present invention attached.

FIG. 7 is a perspective bottom view of the lockout ring according to the present invention alone.

FIG. 8A is a front view of the lockout ring according to the present invention.

FIG. 8B is a left side view of the lockout ring according to the present invention.

FIG. 8C is a right side view of the lockout ring according to the present invention.

FIG. 8D is a top view of the lockout ring according to the present invention.

FIG. 8E is a bottom view of the lockout ring according to the present invention.

FIG. 9 is a cross-sectional view of the lockout ring according to the present invention taken along line 9-9 of FIG. 8D.

Corresponding reference characters indicate corresponding components throughout the several views of the drawings.

### DETAILED DESCRIPTION OF THE INVENTION

The following description is of the best mode presently contemplated for carrying out the invention. This description is not to be taken in a limiting sense, but is made merely for the purpose of describing one or more preferred embodiments of the invention. The scope of the invention should be determined with reference to the claims.

Where the terms “about” or “generally” are associated with an element of the invention, it is intended to describe a feature's appearance to the human eye or human perception, and not a precise measurement.

An open brewing machine 10 according to the present invention is shown in FIG. 1. The brewing machine 10 includes a base 12 and a lid 14. A cartridge positioner 18 resides under the lid 14 and closes onto the base 12 preceding the lid 14 to seat a brewing cartridge 60 (see FIG. 5) in a brewing chamber 16 before an injection nozzle 20 and an extraction nozzle 22 puncture the cartridge 60 when the lid 14 is closed. The extraction nozzle 22 resides offset from the center of the brewing chamber 16. An offset nozzle 24 extends down from the lid 14 and enters a base port 32 to transfer brewed beverage extracted by the extraction needle 22 from the brewing cartridge 36 to the base 12 and into a beverage receptacle which may be a single serving cup or a multi serving carafe. An optical sensor 28 resides on a bottom surface 14a of the lid 14. The cartridge positioner 18 includes a sensor port 30 and an offset nozzle port 26 aligned with the sensor 28 and the offset nozzle 24 respectively.

When the lid 14 is closed on the base 12, the cartridge positioner 18 seats the cartridge 60 in the brewing chamber 16, and then the injection nozzle 20 punctures the cover of single use beverage cartridges and enters through the lid of reusable brewing cartridges. The extraction nozzle 22 may or may not puncture the cover or enter the lid, depending on the type of brewing cartridge in use. Disposable cartridges 60 designed for use in the brewing machine 10 include a visual indicia comprising a color marking read by the optical sensor 28 to determine an amount of heated water to inject into the cartridge 60 from the injection needle 20. Other visual indica may include an image, a texture, a shape, a reflective surface, a combination of one or more of a color, image, a texture, a shape, and a reflective surface or any machine readable visual indicia.

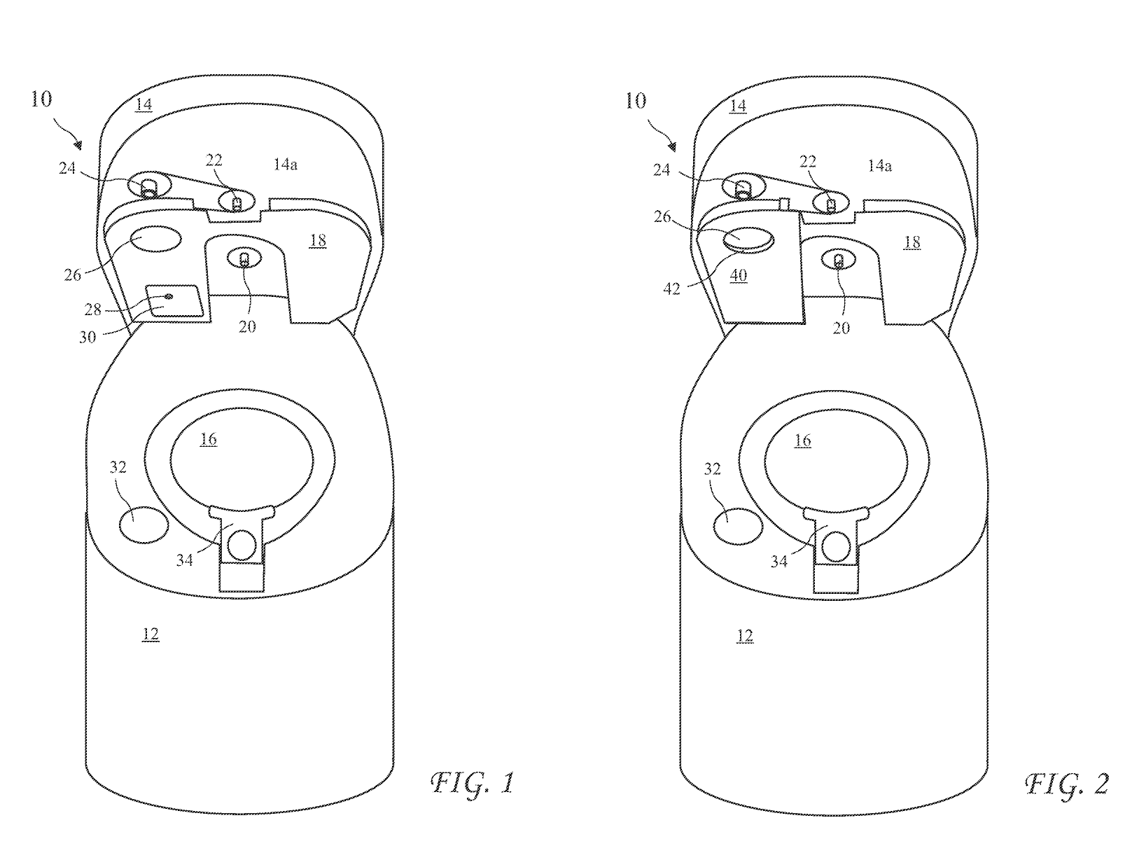

The open brewing machine 10 with a lockout plate 40 according to the present invention attached to the cartridge positioner 18 is shown in FIG. 2. The lockout plate 40 includes an offset nozzle window 42 aligned with the offset nozzle port 26

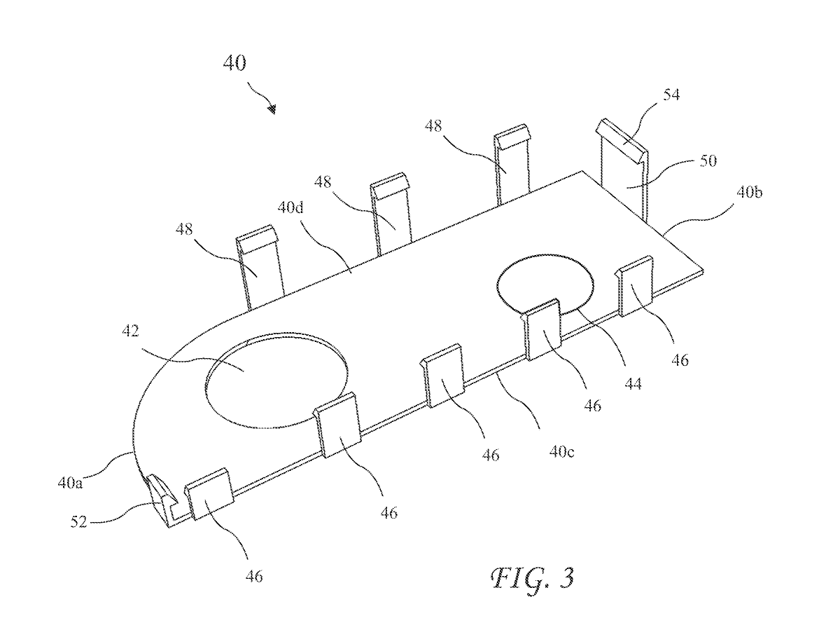

FIG. 3 is a top view of the lockout plate 40 according to the present invention. The lockout plate 40 includes the offset nozzle window 42 which has a cylindrical lip 42a aligned with the offset nozzle port 26 when the lockout plate 40 is attached to the cartridge positioner 18. A visual indicia 44 is aligned with the sensor port 30 and presented to the optical sensor 28 when the lockout plate 40 is attached to the cartridge positioner 18. The visual indicia 44 may be a design indicia, a barcode indicia, or a color indicia informing the brewing machine 10 of the type of cartridge present, for example, a single serving cartridge or a multi serving cartridge, to control the amount of heated water to inject into the cartridge 60 from the injection needle 20.

The lockout plate 40 includes a front 40a, a rear 40b, a right side 40c, and a left side 40d. Hooked tabs 46, 48, 50, and 52 attach the lockout plate 40 to the cartridge positioner 18. Preferably, each side of the lockout plate 40 includes at least one hooked tab. One hooked tab 52 extend up from the front 40a, two hooked tabs 50 extend up from the rear 40b, five hooked tabs 46 extend up from the right side 40c, and three hooked tabs 48 extend up from the left side 40d. Each of the hooked tabs 46, 48, 50, and 52 includes a hook 54 reaching behind and inward to the cartridge positioner 18 to attach the lockout plate 40 to the cartridge positioner 18.

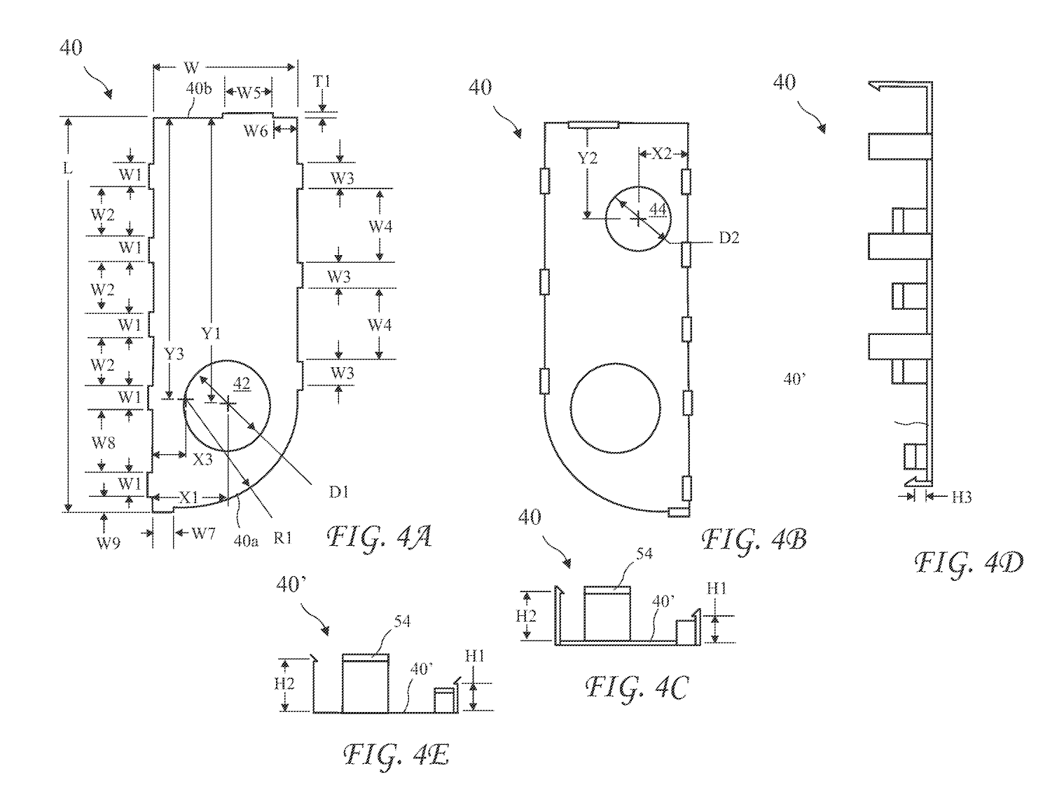

A bottom view of the lockout plate 40 is shown in FIG. 4A, a top view of the lockout plate 40 is shown in FIG. 4B, an end view of the lockout plate 40 is shown in FIG. 4C, and a side view of the lockout plate 40 is shown in FIG. 4D. The lockout plate 40 has an overall length L of preferably about 79.75 mm and a width W of preferably about 29 mm. The five hooked tabs 46 have a width W1 of preferably about 5 mm and spaced apart a width W2 of preferably about 10 mm and W8 with the tab 46 nearest to the front 40a spaced a width W8 of preferably about 12.25 mm from the next tab 46 and a width W9 of preferably about 3 mm from the nearest end of the plate 40. The three hooked tabs 48 have a width W3 of preferably about 5 mm and spaced apart a width W4 of preferably about 15 mm. The hooked tab 50 has a width W5 of preferably about 12 mm and spaced a width W6 from the left side 40d of preferably about 5 mm. The one hooked tab 52 has a width W7 of preferably about 5 mm.

The hook 54 of the three hooked tabs 48 and the two hooked tabs 50 are a height H2 of preferably about 10.25 mm above a top face 40′ of the lockout plate 40. The hook 54 of the five hooked tabs 46 are a height H1 of preferably about 5.5 mm above the bottom face 40′ of the lockout plate 40. The hook 54 of the one hooked tabs 52 are a height H3 of preferably about 2.4 mm above the bottom face 40′ of the lockout plate 40. The measurements H1, H2, and H3 are to a horizontal face of the hook configured to reside against the cartridge positioner 18.

The offset nozzle window 42 has a diameter D1 of preferably about 16 mm, and is centered a distance X1 of preferably about 14.75 mm from the right side 40c, and a distance Y1 of preferably about 58 mm from rear 40b. The visual indicia 44 has a diameter D2 of preferably about 16 mm, and is centered a distance X2 of preferably about 11.5 mm from the right side 40c, and a distance Y2 of preferably about 16.75 mm from rear 40b.

The front 40a has a round portion having a radius R1 of preferably about 22 mm, centered a distance X3 of preferably about 7 mm from the right side 40c and a distance Y3 of preferably about 57 mm from the rear 40b.

A sheet metal lockout plate 40′ is shown in FIG. 4E. The sheet metal lockout plate 40′ reduces thickness of the plate avoiding interference during operation of the coffee maker.

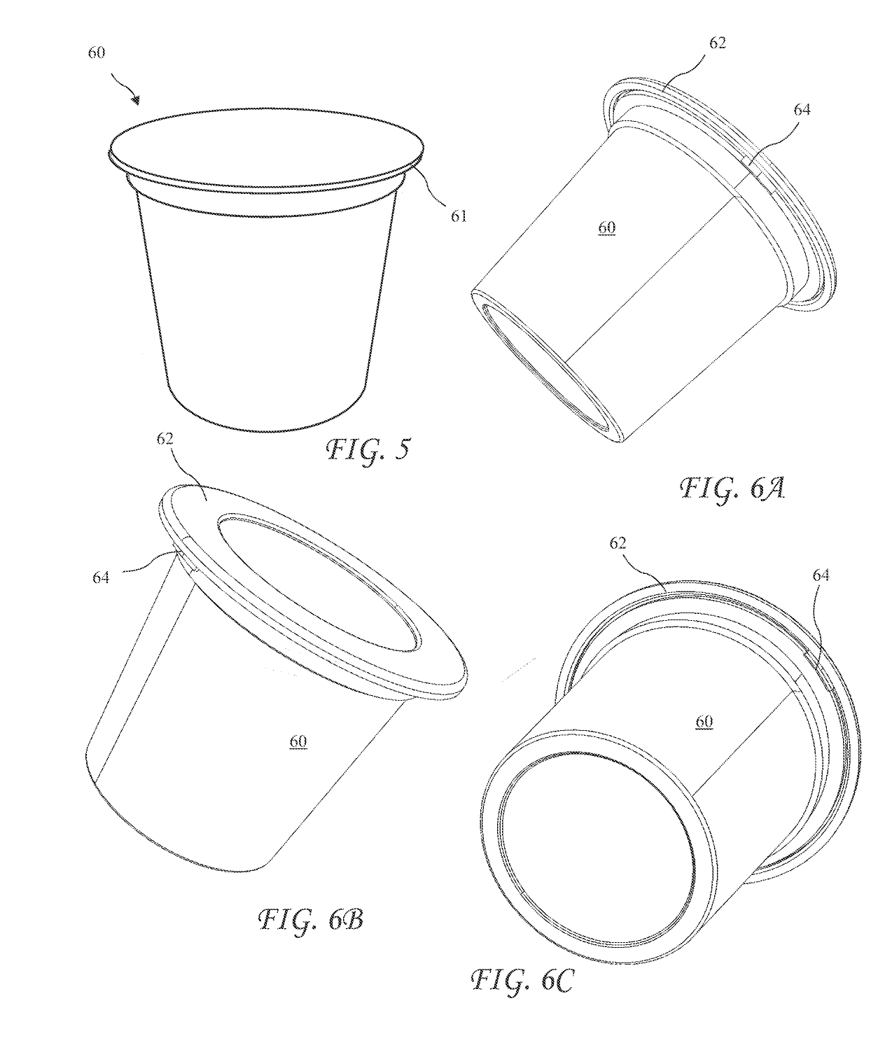

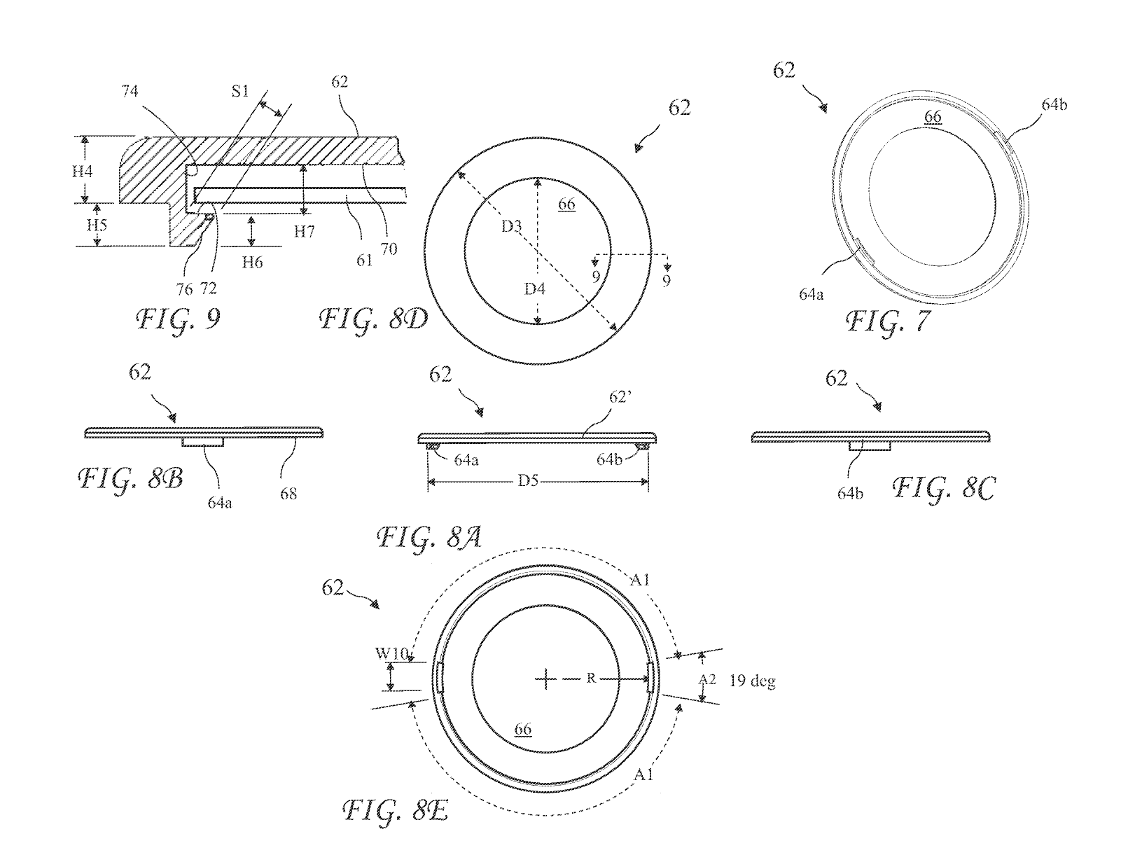

A perspective side view of the brewing cartridge 60 alone is shown in FIG. 5, a perspective side view of the brewing cartridge 60 with a lockout ring 62 attached is shown in FIG. 6A, a perspective top and side view of the brewing cartridge 60 with the lockout ring 62 attached is shown in FIG. 6B, and a perspective bottom and side view of the brewing cartridge 60 with the lockout ring 62 attached is shown in FIG. 6C. The lockout ring 62 preferably includes two hooked clips 64 which engage a rim 61 of the brewing cartridge 60. The lockout ring 62 includes a visual indicia allowing the brewing machine 10 to operate with the cartridge and lockout ring 62 inserted into the brewing machine 10. For example, the lockout ring 62 may be molded of a plastic material having a color indicia informing the brewing machine that the cartridge is a single serving cartridge, or may have the color indicia applies to the lockout ring 62. Other visual indica, for example, an image, a bar code, a texture, a shape, a reflective surface, a readable magnetic strip, a Radio Frequency Identification (RFID), or a combination of one or more of a color, image, a bar code, a texture, a shape, and a reflective surface, a readable magnetic strip, a Radio Frequency Identification (RFID) or any machine readable visual indicia.

A perspective bottom view of the lockout ring 62 is shown in FIG. 7, a front view of the lockout ring 62 is shown in FIG. 8A, a left side view of the lockout ring 62 is shown in FIG. 8B, a right side view of the lockout ring 62 is shown in FIG. 8C, a top view of the lockout ring 62 is shown in FIG. 8D, a bottom view of the lockout ring 62 is shown in FIG. 8E, and a cross-sectional view of the lockout ring 62 taken along line 9-9 of FIG. 8D is shown in FIG. 9. The lockout ring 62 has an outside diameter D3 of preferably about 55 mm, an open center 66 having an inside diameter D4 of preferably about 36 mm. The open center 66 allows access of the injection needle to puncture the cartridge 62.

The lockout ring 62 preferably includes two hooked tabs 64a and 64b. The lockout ring 62 has a height H4 of preferably about 2 mm and the hooked tabs 64a and 64b are spaced a height H5 of preferably about 1.3 mm below a bottom edge 68′ of the lockout ring 62 and reach in step depth S1 of preferably about 0.573 mm inches. Inside faces 74 of the hooked tabs 64a and 64b are at a radius R of preferably about 25.5 mm. The hooked tabs 64 extend an angle A2 of preferably about 19 degrees and the hooked tabs 64a and 64b have a width W10 of preferably about 7 mm. To positively attach the lockout ring 62 to the brewing cartridge 60, an angle A1 between ends of the side hooked tabs 64a and 64b is preferable less than 180 degrees.

The tabs 64a and 64b include a shelf 72 and ramps 76 to facilitate slipping or snapping the lockout ring 62 over the rim 61 of the brewing cartridge 60.

While the invention herein disclosed has been described by means of specific embodiments and applications thereof, numerous modifications and variations could be made thereto by those skilled in the art without departing from the scope of the invention set forth in the claims.

I claim:

1. A brewing machine insert, comprising:
a lockout device configured to reside above a brewing chamber of a brewing machine, the lockout device including a brewing indicia; and
attaching features of the lockout device configured to cooperate with one of the brewing machine and a brewing cartridge to position the visual indicia under an optical sensor attached to a bottom surface of a lid of the brewing machine.

2. The brewing machine insert of claim 1, wherein the lockout device comprises a lockout plate configured to attach to a bottom surface of a lid of the brewing machine.

3. The brewing machine insert of claim 2, wherein the lockout plate comprises:
a visual indicia on a top surface of a rear portion of the lockout plate; and
an offset nozzle window on a front portion of the lockout plate.

4. The brewing machine insert of claim 3, wherein the lockout plate configured to attach to a brewing machine cartridge positioner.

5. The brewing machine insert of claim 4, wherein the lockout plate includes a multiplicity of hooked tabs reaching up on sides of the cartridge positioner, the hooks engaging the cartridge positioner to retain the lockout plate to the cartridge positioner.

6. The brewing machine insert of claim 5, wherein the lockout plate has a length L of about 70 mm and a width W of about 29 mm.

7. The brewing machine insert of claim 6, wherein the brewing indicia is a visual indicia.

8. The brewing machine insert of claim 6, wherein the visual indicia is a color indicia.

9. The brewing machine insert of claim 8, wherein the lockout plate is made from sheet metal.

10. The brewing machine insert of claim 1, wherein the lockout device comprises a lockout ring attachable to a brewing cartridge.

11. The brewing machine insert of claim 10, wherein the lockout ring includes two opposing hooked tabs configured to attach the lockout ring to the brewing cartridge.

12. The brewing machine insert of claim 11, wherein the lockout ring includes an open center.

13. The brewing machine insert of claim 12, wherein the open center has a diameter of about 36 mm.

14. The brewing machine insert of claim 13, wherein the lockout ring has an outside diameter of about 55 mm.

15. The brewing machine insert of claim 10, wherein the brewing indicia is a visual indicia.

16. The brewing machine insert of claim 15, wherein the visual indicia is a color indicia.

17. A brewing machine insert, comprising:
a sheet metal lockout plate configured to attach to a bottom surface of a brewing machine cartridge positioner, the lockout plate comprising:
a length L of 79.75 mm and a width W of 29 mm;
a color indicia on a top surface of a rear portion of the lockout plate;
an offset nozzle window on a front portion of the lockout plate; and
a multiplicity of hooked tabs on at least three sides of the lockout plate, the hooked tabs configured to engage the cartridge positioner.

18. A brewing machine insert, comprising:
a lockout ring attachable to a brewing cartridge, the lockout ring comprising:
a color indicia;
an open center having a diameter of 36 mm; and
outside diameter of 55 mm;
a height H4 of 2 mm;
two opposing hooked tabs configured to attach the lockout ring to the brewing cartridge, the two hooked tabs reaching below a bottom edge of the lockout ring a height H5 of 1.3 mm and having widths W10 of 7 mm.
